(19) United States
(12) Patent Application Publication
(10) Pub. No.: US 2022/0222950 A1
(43) Pub. Date: Jul. 14, 2022

(54) FATIGUE DETECTION METHOD AND APPARATUS, AND READABLE STORAGE MEDIUM

(71) Applicants: CHENGDU KUANGSHI JINZHI TECHNOLOGY CO., LTD., Chengdu, Sichuang (CN); BEIJING KUANGSHI TECHNOLOGY CO., LTD., Beijing (CN)

(72) Inventors: Shan ZHAO, Chengdu, Sichuan (CN); Donghao LIU, Chengdu, Sichuan (CN); Kunuming LUO, Chengdu, Sichuan (CN); Shuaicheng LIU, Chengdu, Sichuan (CN)

(21) Appl. No.: 17/609,007

(22) PCT Filed: May 14, 2020
(86) PCT No.: PCT/CN2020/090191

§ 371 Date: Nov. 5, 2021

(30) Foreign Application Priority Data
May 17, 2019 (CN) 201910413454.4

(51) Int. Cl. G06V 20/59; G06V 10/82

(52) U.S. Cl. CPC G06V 20/597; G06V 10/82

(57) ABSTRACT

A fatigue detecting method includes: obtaining an eye image of a driver (S101); inputting the eye image into a target convolutional neural network, to obtain eye-state data contained in the eye image, wherein the eye-state data represents a degree of opening of an eye of the driver, and the target convolutional neural network is obtained by training a convolutional neural network by using eye-image samples that are collected in advance (S102); and in a condition that respective eye-state data of a plurality of frames of eye images are obtained, according to the respective eye-state data of the plurality of frames of eye images, determining whether the driver is in a fatigue state (S103). Therefore, the method can more easily determine whether the driver is in the fatigue state, and, by using the target convolutional neural network, can realize real-time detection on whether the driver is in the fatigue state.

The present application claims the priority of the Chinese patent application filed on May 17, 2019 before the Chinese Patent Office with the application number of 201910413454.4 and the title of “FATIGUE DETECTION METHOD AND APPARATUS, AND READABLE STORAGE MEDIUM”, which is incorporated herein in its entirety by reference.

### TECHNICAL FIELD

The present disclosure relates to the technical field of image processing, and particularly relates to a fatigue detecting method and apparatus and a readable storage medium.

### BACKGROUND

With the development of the levels of social economy and science and technology, the amount of motor cars is increasing steadily, which highly facilitates the travelling of people. Currently, cars have already become one of the most popular vehicles, but a concurrent problem is that traffic accidents happen more frequently. According to incomplete statistics, a considerable part of those traffic accidents are caused by fatigue driving of the driver. Therefore, in order to reduce the accident rate, to protect the lives and the property of people, it is urgently required to solve the problem of fatigue driving.

In the related art, a detection method based on the travelling trajectory of a car is used to detect whether the driver is fatigue. The method focuses on the deviation of the travelling direction of the car caused by the pattern of behavior of the driver, for example, detecting the angle of rotation of the steering wheel by the driver, the pressure on the steering wheel by the driver, or the lane deviation distance. However, because the method is influenced by the interference factors such as the personal driving habits, the travelling speed, the road environment and the operating skill, the method has a high difficulty in determining whether the driver is fatigue.

### SUMMARY

In view of the above problems, the embodiments of the present disclosure are proposed to provide a fatigue detecting method and apparatus and a readable storage medium that can overcome the above problems or at least partially solve the above problems.

In the first aspect of the present disclosure, there is provided a fatigue detecting method, wherein the method comprises:

obtaining an eye image of a driver;

inputting the eye image into a target convolutional neural network, to obtain eye-state data contained in the eye image, wherein the eye-state data represents a degree of opening of an eye of the driver, and the target convolutional neural network is obtained by training a convolutional neural network by using eye-image samples that are collected in advance; and

in a condition that respective eye-state data of a plurality of frames of eye images are obtained, according to the respective eye-state data of the plurality of frames of eye images, determining whether the driver is in a fatigue state.

In the second aspect of the present disclosure, there is provided a fatigue detecting apparatus, wherein the apparatus comprises:

an obtaining module configured for obtaining an eye image of a driver;

an inputting module configured for inputting the eye image into a target convolutional neural network, to obtain eye-state data contained in the eye image, wherein the eye-state data represents a degree of opening of an eye of the driver, and the target convolutional neural network is obtained by training a convolutional neural network by using eye-image samples that are collected in advance; and

a determining module configured for, in a condition that respective eye-state data of a plurality of frames of eye images are obtained, according to the respective eye-state data of the plurality of frames of eye images, determining whether the driver is in a fatigue state.

In the third aspect of the present disclosure, there is provided a computer-readable storage medium, wherein the computer-readable storage medium stores a computer program, and the computer program, when executed by a processor, implements the steps of the fatigue detecting method according to any one of the above aspects.

In the fourth aspect of the present disclosure, there is provided a fatigue detecting apparatus, wherein the fatigue detecting apparatus comprises a processor, a memory and a computer program that is stored in the memory and is executable in the processor, and the computer program, when executed by the processor, implements the steps of the fatigue detecting method according to any one of the above aspects.

The embodiments of the present disclosure have the following advantages:

The fatigue detecting method and apparatus and the readable storage medium according to the embodiments of the present disclosure, by obtaining an eye image of a driver; inputting the eye image into a target convolutional neural network, to obtain eye-state data contained in the eye image, wherein the eye-state data represents a degree of opening of an eye of the driver, and the target convolutional neural network is obtained by training a convolutional neural network by using eye-image samples that are collected in advance; and according to the eye-state data contained individually in the plurality of frames of eye images of the driver, determining whether the driver is in a fatigue state, can more easily determine whether the driver is in the fatigue state, and, by using the target convolutional neural network, can realize real-time detection on whether the driver is in the fatigue state.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present disclosure are provided below.

### BRIEF DESCRIPTION OF THE DRAWINGS

By reading the following detailed description of the preferable embodiments, various other advantages and benefits will become clear to a person skilled in the art. The drawings are merely intended to show the preferable embodiments, and are not to be considered as limiting the present disclosure. Furthermore, throughout the drawings, the same reference signs denote the same elements. In the drawings:

FIG. 1 is a flow chart of the steps of the fatigue detecting method according to an embodiment of the present disclosure;

FIG. 2 is a flow chart of the steps of the fatigue detecting method according to another embodiment of the present disclosure;

FIG. 3 is a flow chart of the particular steps of the fatigue detecting method according to an embodiment of the present disclosure;

FIG. 4 is a flow chart of the particular steps of the fatigue detecting method according to another embodiment of the present disclosure;

FIG. 5 is a schematic structural diagram of the fatigue detecting apparatus according to an embodiment of the present disclosure;

FIG. 6 is a schematic structural diagram of the fatigue detecting apparatus according to another embodiment of the present disclosure;

FIG. 7 schematically shows a block diagram of a calculating and processing device for implementing the method according to the present disclosure; and

FIG. 8 schematically shows a storage unit for maintaining or carrying a program code for implementing the method according to the present disclosure.

### DETAILED DESCRIPTION

In order to make the objects, the technical solutions and the advantages of the embodiments of the present disclosure clearer, the technical solutions of the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

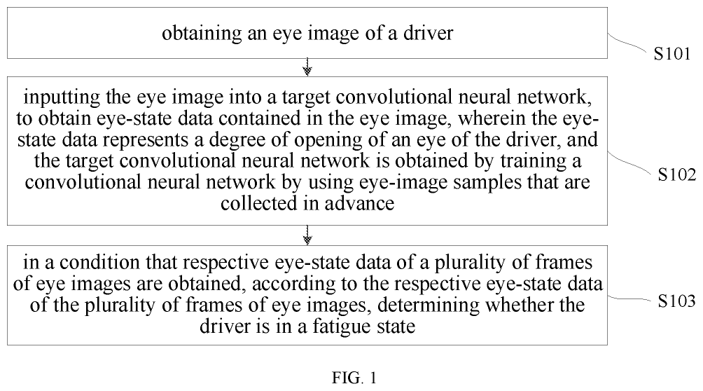

FIG. 1 is a flow chart of the steps of the fatigue detecting method according to an embodiment of the present disclosure. The fatigue detecting method according to the present embodiment is adapted for determining whether a driver is in the situation of fatigue driving. The fatigue detecting method may be implemented by a fatigue detecting apparatus, and the fatigue detecting apparatus is usually embodied as software and/or hardware. Referring to FIG. 1, the method according to the present embodiment comprises the following steps:

S101: obtaining an eye image of a driver.

The eye image of the driver may be an RGB image, and may also be an infrared image. RGB colors are the often said three primary colors, wherein R represents Red, G represents Green, and B represents Blue, and RGB are the colors that represent the three channels of red, green and blue. For example, when the driver is driving in a situation where the light rays are dark, for example, at night, the obtained eye image of the driver is an infrared image photographed by using an infrared camera, and, in an environment where the light rays are sufficient, obtained is an RGB image photographed by using an RGB camera.

S102: inputting the eye image into a target convolutional neural network, to obtain eye-state data contained in the eye image, wherein the eye-state data represents a degree of opening of an eye of the driver, and the target convolutional neural network is obtained by training a convolutional neural network by using eye-image samples that are collected in advance.

By inputting one frame of eye image into a target convolutional neural network, and processing the eye image by using the target convolutional neural network, one datum that indicates the degree of the opening of the eyes (for example, that datum is a datum that is greater than or equal to 0 and less than or equal to 1) can be obtained, wherein 0 represents that the eyes are closed, and 1 represents that the eyes are opened widely to the extent that the entire regions of the iris can be seen. It should be noted that the obtained data that indicate the degree of the opening of the human eyes may also be data within other ranges, for example, data that are greater than or equal to 1 and less than or equal to 10, wherein 1 represents that the eyes are closed, and 10 represents that the eyes are opened widely to the extent that the entire regions of the iris can be seen. The particularly form of the obtained data that indicate the degree of the opening of the human eyes is not limited in the present disclosure.

The eye-image samples that are collected in advance are the training data. For example, the training data may be formed by 100 thousand eye images that are generated by the rendering tool UnityEyes. UnityEyes is a 3D rendering tool, and can generate highly diversified pictures of the left eye by setting the range of the camera parameters and the range of the sight-line parameters. The camera parameters of UnityEyes are set to be (0,−20,30,50), and the sight-line parameters are set to be (30,0,20,45). By setting the camera parameters and the sight-line parameters, the pictures of the left eye that are photographed in environments of different light rays with the camera being in different positions and at different angles can be obtained. For example, a photograph of the left eye is photographed in an environment of dark light when the camera is in a side position. After the convolutional neural network has been trained by using the training data, the target convolutional neural network is obtained, and the target convolutional neural network processes the eye images, to obtain the eye-state data contained in the eye images, i.e., obtain the data indicating the degree of the opening of the human eyes. Because the training data contain the eye images when the camera is in different positions and in environments of different light rays, the target convolutional neural network obtained by training the convolutional neural network by using the training data can estimate the state data of the eyes of the eye images that are photographed when the camera is at different angles and in environments of different light rays; in other words, the eye-state data contained in the eye images in different scenes are obtained by using the target convolutional neural network. In driving, the driver might not always look straight ahead, and might drive in environments of dark light rays, for example, at night. For such scenes, the target convolutional neural network can also estimate the eye-state data of the driver, and therefore it has a good practical applicability.

S103: in a condition that respective eye-state data of a plurality of frames of eye images are obtained, according to the respective eye-state data of the plurality of frames of eye images, determining whether the driver is in a fatigue state.

It should be noted that it is not required to determine whether the driver is in the fatigue state within the first five seconds after the car starts. Beginning from the first frame of eye image obtained at the 6th second, the first frame of eye image obtained at the 6th second is inputted into the target convolutional neural network, to obtain the eye-state data contained in the first frame of eye image. Subsequently, the obtained second frame of eye image is also inputted into the target convolutional neural network, to obtain the eye-state data contained in the second frame of eye image. Subsequently, every time one frame of eye image is obtained, the obtained one frame of eye image is inputted into the target convolutional neural network, to obtain the eye-state data contained in the one frame of eye image. It may be determined whether the driver is in the fatigue state according to the eye-state data contained individually in the obtained plurality of frames of eye images. For example, in the obtained first 18000 frames of images, the eye-state data contained in each of the obtained frames of eye images are between 0.8 and 1; for the 18001th frame of eye image, the eye-state data contained in the one frame of eye image is 0.7; the eye-state data contained in the 18002th frame of eye image is 0.6; the eye-state data contained in the 18003th frame of eye image is 0.5; and the eye-state data contained in the 18004th and the 18005th frames of eye images are 0.4. If, subsequently, the eye-state data contained individually in the 18006th to the 18080th frames of eye images are between 0 and 0.3, the state data between 0 and 0.3 may be considered as that the driver is in the state in which the eyes are nearly closed. If 30 frames of eye images can be obtained every second, then when the eye-state data contained individually in the 75 frames of eye images are between 0 and 0.3, it is considered that the duration when the driver is in the state in which the eyes are nearly closed is 2.5 seconds. The duration when the eyes are nearly closed is too long, and it can be determined that the driver is in the fatigue state. If, subsequently, the eye-state data contained in the 18006th frame of eye image is 0.5, the eye-state data contained in the 18007th frame of eye image is 0.6, and the eye-state data contained individually in the 18008th to the 18080th frames of eye images are between 0.7 and 1, it can be determined that the driver is not in the fatigue state.

It should be noted that, because the fatigue detecting method according to the present embodiment merely performs analysis and processing on the eye images of the driver obtained by using the target convolutional neural network, to obtain the eye-state data contained in the eye images, thereby, according to the eye-state data contained individually in the plurality of frames of eye images of the driver, determining whether the driver is in a fatigue state, the solution is not influenced by the interference factors such as the personal driving habits, the travelling speed, the road environment and the operating skill, can more easily determine whether the driver is in the fatigue state, and, by using the lightweight target convolutional neural network, can realize real-time detection on whether the driver is in the fatigue state.

The fatigue detecting method according to the present embodiment, by obtaining an eye image of a driver; inputting the eye image into a target convolutional neural network, to obtain eye-state data contained in the eye image, wherein the eye-state data represents a degree of opening of an eye of the driver, and the target convolutional neural network is obtained by training a convolutional neural network by using eye-image samples that are collected in advance; and according to the eye-state data contained individually in the plurality of frames of eye images of the driver, determining whether the driver is in a fatigue state, can more easily determine whether the driver is in the fatigue state, and, by using the target convolutional neural network, can realize real-time detection on whether the driver is in the fatigue state.

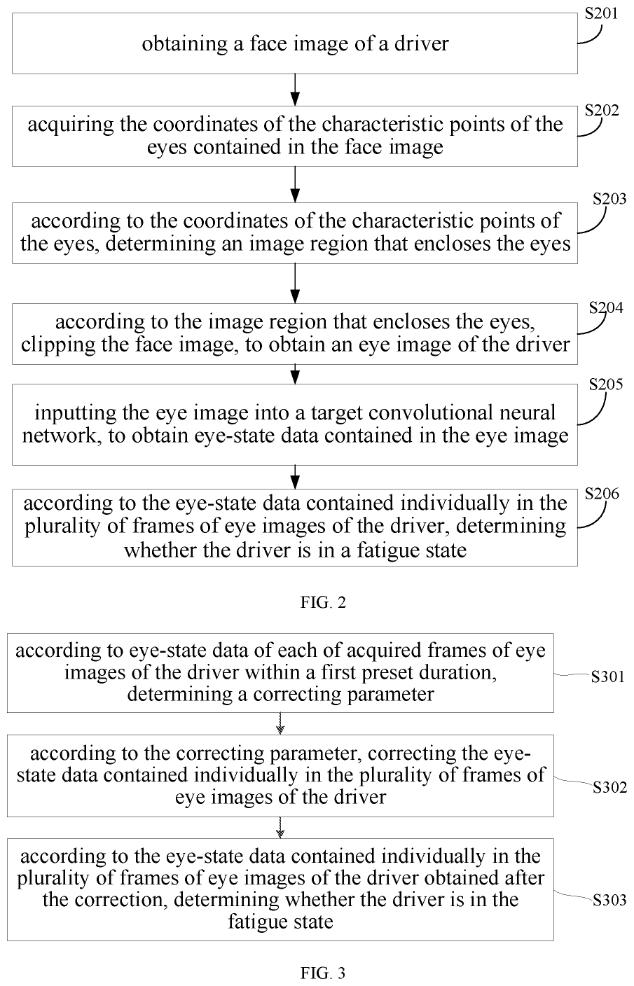

On the basis of the above embodiment, referring to FIG. 2, FIG. 2 is a flow chart of the steps of the fatigue detecting method according to another embodiment of the present disclosure. The fatigue detecting method according to the present embodiment may comprise the following steps:

S201: obtaining a face image of a driver.

S202: acquiring the coordinates of the characteristic points of the eyes contained in the face image.

The human-face characteristic points of the face image may be extracted by using a characteristic-point detection algorithm (for example, the MegFace toolkit), which toolkit can accurately and quickly extract the coordinates of the human-face characteristic points. The coordinates of the human-face characteristic points include the coordinates of the characteristic points of the eyebrows, the eyes, the nose, the mouth and the face region. The coordinates of the characteristic points of the eyes are acquired from the coordinates of the human-face characteristic points, the coordinates of the characteristic points of the eyes may include the coordinates of the characteristic points of the left eye and the coordinates of the characteristic points of the right eye. The characteristic points may also be extracted by using other databases; for example, the Dlib database may be used. The Dlib database is written by using C++, and provides a series of functions related to the fields such as machine learning, numerical-value calculation, graphical-model algorithm, and image processing.

S203: according to the coordinates of the characteristic points of the eyes, determining an image region that encloses the eyes.

The step of, according to the coordinates of the characteristic points of the eyes, determining the image region that encloses the eyes may be implemented by the following steps:

According to the coordinates of the characteristic points of the left eye/the right eye, determining the area of a smallest first rectangular block that encloses the left eye/the right eye, and, according to the coordinates of the characteristic points of the right eye/the left eye, determining the area of a smallest second rectangular block that encloses the right eye/the left eye; selecting the largest area from the area of the first rectangular block and the area of the second rectangular block; and determining the rectangular block corresponding to the largest area to be the image region that encloses the eyes.

For example, if the area of the first rectangular block corresponding to the left eye is greater than the area of the second rectangular block corresponding to the right eye, the first rectangular block is determined to be the image region that encloses the left eye.

The rectangular block corresponding to the larger area is selected to be the image region that encloses the eyes, whereby, when the driver is performing amusing-type blinking (for example, the driver intentionally performs one-side blinking, with the eye on the opposite side opened), the image region corresponding to the opened eye can be selected. Therefore, in the execution of the subsequent steps, the current state of the driver can be analyzed more accurately, i.e., more accurately analyzing whether the driver is in the fatigue state.

S204: according to the image region that encloses the eyes, clipping the face image, to obtain an eye image of the driver.

If the image region that encloses the eyes is an image region that encloses the left eye, the face image is clipped, to obtain an image region that encloses the left eye/the right eye.

S205: inputting the eye image into a target convolutional neural network, to obtain eye-state data contained in the eye image.

If the image region that encloses the left eye is inputted into the target convolutional neural network, the eye-state data contained in the image of the left eye can be obtained.

Before the eye image is inputted into the target convolutional neural network, it is required to obtain the target convolutional neural network, wherein the target convolutional neural network is a target convolutional neural network obtained by the following steps:

obtaining an eye-image sample by using a rendering tool; according to coordinates of characteristic points of a left eye and a right eye contained in the eye-image sample, clipping the eye-image sample, to obtain an image that encloses the left eye and the right eye of the eye-image sample; flipping the image that encloses the left eye and the right eye of the eye-image sample into an image of the right eye and the left eye; and inputting the image that encloses the left eye and the right eye of the eye-image sample and the image of the right eye and the left eye obtained after the flipping into the convolutional neural network, and training, to obtain the target convolutional neural network.

According to the coordinates of the characteristic points of the left eye and the right eye contained in the eye-image sample, the distance between the upper eyelid and the lower eyelid and the iris diameter may be calculated, thereby obtaining one datum that indicates the degree of the opening of the eyes, and by using the datum as the label of the eye-image sample, the convolutional neural network is trained. For example, the degree of the opening of the eyes is equal to the quotient obtained by dividing the distance between the upper eyelid and the lower eyelid by the iris diameter. If the image that encloses the left eye of the eye-image sample is inputted into the convolutional neural network to be trained, the convolutional neural network will output one datum that indicates the degree of the opening of the eye. If that datum is closer to the degree of the opening of the eye that is obtained by dividing the distance between the upper eyelid and the lower eyelid by the iris diameter, that indicates that the trained convolutional neural network is closer to convergence.

It should be noted that, if the image that encloses the left eye of the eye-image sample is obtained, the image that encloses the left eye of the eye-image sample is flipped into an image of the right eye, and if the image that encloses the right eye of the eye-image sample is obtained, the image that encloses the right eye of the eye-image sample is flipped into an image of the left eye. The target convolutional neural network is a lightweight target convolutional neural network. By “lightweight”, it is meant that the target convolutional neural network has a few parameters and a small calculated amount, which can ensure that the lightweight target convolutional neural network quickly outputs the eye-state data, and can satisfy the required speed for practical applications.

The step of inputting the image that encloses the left eye and the right eye of the eye-image sample and the image of the right eye and the left eye obtained after the flipping into the convolutional neural network, and training may be implemented by using the following mode:

if the image that encloses the left eye of the eye-image sample and the image of the right eye are RGB images, inputting red channels of the image that encloses the left eye of the eye-image sample and the image of the right eye into the convolutional neural network, and training; and

if the image that encloses the left eye of the eye-image sample and the image of the right eye are infrared images, inputting the image that encloses the left eye of the eye-image sample and the image of the right eye into the convolutional neural network, and training.

It should be noted that, if the training data obtained by using the rendering tool include the left eye, it is required to randomly flip the left eye into the right eye, whereby the inputted training data of the convolutional neural network include the image of the left eye and the image of the right eye. If the training data obtained by using the rendering tool include the right eye, it is required to randomly flip the right eye into the left eye, whereby the inputted training data of the convolutional neural network include the image of the left eye and the image of the right eye. Furthermore, in order to enable the model that has already been trained (the model that has already been trained refers to the target neural network) to be used to estimate simultaneously the eye-state data of the human eyes in the pictures photographed by the RGB camera and the infrared camera, during the training, if the eye image is an RGB image, the red channel of the RGB image is selected to be inputted into the convolutional neural network, if the eye image is an infrared image, it may be directly inputted into the convolutional neural network for the training. The rendering tool may be an UnityEyes rendering tool.

S206: according to the eye-state data contained individually in the plurality of frames of eye images of the driver, determining whether the driver is in a fatigue state.

Particularly, referring to FIG. 3, FIG. 3 is a flow chart of the particular steps of the fatigue detecting method according to an embodiment of the present disclosure. S206 of, according to the eye-state data contained individually in the plurality of frames of eye images of the driver, determining whether the driver is in the fatigue state, may be implemented by the following steps:

S301: according to eye-state data of each of acquired frames of eye images of the driver within a first preset duration, determining a correcting parameter.

According to eye-state data of each of acquired frames of eye images of the driver within a first preset duration, a correcting parameter is determined. The average value of a preset maximum amount (n) of the state data within a first preset duration is taken; for example, the first preset duration is 5 seconds, and the preset amount (n) is 10. If 30 frames of eye images can be acquired every second, 150 state data are correspondingly acquired from the 150 acquired frames of eye images. 10 state data with the maximum numerical values are selected from the 150 state data, and the average value of the 10 state data are used as the correcting parameter. In the embodiments of the present disclosure, the amount n is not limited.

S302: according to the correcting parameter, correcting the eye-state data contained individually in the plurality of frames of eye images of the driver.

The correction of the eye-state data contained individually in the plurality of frames of eye images of the driver may be by the following two modes. In a possible implementation, the eye-state data contained individually in the plurality of frames of eye images of the driver may be corrected according to the correcting parameter, and the eye-state data obtained after the correction is equal to the quotient obtained by dividing the eye-state data estimated by the target convolutional neural network by the correcting parameter. For example, if the eye-state data contained in the current frame of eye image estimated by the target convolutional neural network is equal to 0.75, and the correcting parameter is equal to 0.8, the eye-state data contained in the current frame of eye image obtained after the correction is equal to the quotient obtained by dividing 0.75 by 0.8.

In the other possible implementation, the eye-state data contained individually in the plurality of frames of eye images of the driver may be corrected according to the correcting parameter and the head deflection angles of the driver corresponding individually to the plurality of frames of eye images. The eye-state data obtained after the correction is equal to the quotient obtained by dividing the eye-state data estimated by the target convolutional neural network by the correcting parameter and the cosine value of the head deflection angle. It should be noted that the head deflection angles of the driver corresponding individually to the plurality of frames of eye images may be obtained. One frame of eye image corresponds to one head deflection angle; in other words, every time one frame of eye image is obtained, the head deflection angle corresponding to the one frame of eye image is required to be obtained. The head deflection angle may be obtained by using a characteristic-point detection algorithm (for example, the MegFace toolkit). For example, when the driver is looking straight ahead, the head deflection angle is 0; when the driver is raising his head by 10 degrees, the head deflection angle is 350 degrees; and when the driver is lowering his head by 10 degrees, the head deflection angle of the driver is 10 degrees.

It should be noted that, because the head deflection of the driver will result in that the eye-state data of the same eye present different visual effects in the eye images, and the eye openings that are calculated out by inputting the eye images into the same convolutional neural network will be different, when the eye-state data contained individually in the plurality of frames of eye images are corrected by taking into consideration the head deflection angle, the eye-state data obtained after the correction can be more accurate.

Particularly, the method of, according to the correcting parameter and the head deflection angles of the driver corresponding individually to the plurality of frames of eye images, correcting the eye-state data obtained by the target convolutional neural network is, for example: if the correcting parameter that is determined by using the 150 frames of eye images within the first 5 seconds is 0.8, then, if the first frame of eye image is obtained at the 6th second, the head deflection angle of the driver corresponding to the first frame of eye image is 350 degrees, and the eye-state data contained in the first frame of eye image estimated by the target convolutional neural network is 0.75, then the eye-state data obtained after the correction may be obtained by dividing 0.75 by the product between the correcting parameter and the cosine value of 350; in other words, the eye-state data contained in the first frame of eye image obtained after the correction is the quotient obtained by dividing 0.75 by the product between the correcting parameter and the cosine value of 350.

By correcting the eye-state data contained in the eye images estimated by the target convolutional neural network, the eye-state data obtained after the correction can be more closer to the true values, it can be more accurately determined whether the driver is in the fatigue state.

S303: according to the eye-state data contained individually in the plurality of frames of eye images of the driver obtained after the correction, determining whether the driver is in the fatigue state.

Particularly, S303 of, according to the eye-state data contained individually in the plurality of frames of eye images of the driver obtained after the correction, determining whether the driver is in the fatigue state, may be implemented by using the following three modes.

The first mode may comprise the following steps:

according to a change of the eye-state data contained individually in the plurality of frames of eye images of the driver obtained after the correction, determining a blinking process of the driver;

determining a first counted-up frame amount during the blinking process and a total frame amount during the blinking process, wherein the first counted-up frame amount is determined according to a counted-up frame amount of the eye images during the blinking process obtained after the correction whose state data are less than or equal to a preset first threshold, the total frame amount is determined according to a counted-up frame amount of the eye images during the blinking process obtained after the correction whose state data are less than or equal to a preset second threshold, and the first threshold is less than the second threshold; and

if a ratio of the first counted-up frame amount to the total frame amount is greater than or equal to a preset third threshold and the first counted-up frame amount is greater than or equal to a preset fourth threshold, determining that the driver is in the fatigue state.

For example, the first frame of eye image obtained at the 6th second is inputted into the target convolutional neural network, to obtain the eye-state data contained in the first frame of eye image, and the eye-state data is corrected to obtain the eye-state data obtained after the correction. Subsequently, the obtained second frame of eye image is also inputted into the target convolutional neural network, to obtain the eye-state data contained in the second frame of eye image. The eye-state data is corrected to obtain the eye-state data obtained after the correction. Subsequently, every time one frame of eye image is obtained, the obtained one frame of eye image is inputted into the target convolutional neural network, to obtain the eye-state data contained in the one frame of eye image, and the eye-state data is corrected to obtain the eye-state data obtained after the correction. For example, for the first 18000 obtained frames of eye images (for example, 18000 frames of eye images are obtained within 10 minutes), the eye-state data contained in each of the obtained frames of eye images obtained after the correction are between 0.8 and 1. For the 18001th frame of eye image, the eye-state data contained in the one frame of eye image obtained after the correction is 0.7 (if the second threshold is 0.7). Accordingly, the 18001th frame is determined as the blinking starting frame, and the initial value of the total frame amount is 0. At this point, the total frame amount is added 1, or, in other words, the total frame amount is equal to 1. The eye-state data contained in the 18002th frame of eye image is 0.6. After the total frame amount is added 1 again, the total frame amount is equal to 2, and the eye-state data contained in the 18003th frame of eye image obtained after the correction is 0.5. After the total frame amount is added 1 again, the total frame amount is equal to 3, and the eye-state data contained in the 18004th and the 18005th frames of eye images obtained after the correction are 0.4. The total frame amount is equal to 5. If, subsequently, the eye-state data contained in the 18006th frame of eye image obtained after the correction is 0.5, (if the first threshold is 0.3, or, in other words, if the eye-state data of the current frame of eye image obtained after the correction is less than or equal to 0.3, it is considered that the one frame is a nearly-eye-closing frame or an eye-closing frame), then the first counted-up frame amount is added 1, and, as the initial value of the first counted-up frame amount is 0, after added 1, the first counted-up frame amount is equal to 1. Furthermore, after the total frame amount is added 1, the total frame amount is equal to 6. Subsequently, every time the eye-state data of one frame of eye image obtained after the correction that is less than or equal to 0.3 is obtained, the first counted-up frame amount is executed an adding-1 operation and the total frame amount is also executed an adding-1 operation. If the eye-state data contained individually in the 18007th to the 18080th frames of eye images obtained after the correction are between 0 and 0.3, then at the 18080th frame, the first counted-up frame amount is equal to 75, and the total frame amount is equal to 80. If the eye-state data contained in the 18001th frame of eye image obtained after the correction is 0.4, then the first counted-up frame amount is not executed an adding-1 operation (because 0.4 is greater than the preset first threshold 0.3), the total frame amount is executed an adding-1 operation, and after the total frame amount is added 1, the total frame amount is equal to 81. If, subsequently, the eye-state data contained individually in the 18082th frame to the 18100th frame of eye images obtained after the correction are greater than 0.4 and less than 0.7, or, in other words, the degree of the opening of the eyes is increasing, during that, the first counted-up frame amount is not executed an adding-1 operation, the total frame amount is required to continue to be executed an adding-1 operation, and the total frame amount at this point is equal to 100. If the eye-state data contained in the 18101th frame of eye image obtained after the correction is 0.7, then the total frame amount continues to be executed an adding-1 operation and is then equal to 101, and the first counted-up frame amount is equal to 75. If the eye-state data contained in the 18102th frame of eye image obtained after the correction is 0.8 (because 0.8 is greater than the preset second threshold), or, in other words, at the 18102th frame, the total frame amount and the first counted-up frame amount are not executed an adding-1 operation, at the 18101th frame, the blinking process ends; in other words, the 18001th frame to the 18101th frame is the blinking process. When the blinking process ends, the calculated ratio of the first counted-up frame amount to the total frame amount is the quotient obtained by dividing 75 by 101, and if the ratio is greater than a preset third threshold and the first counted-up frame amount is greater than or equal to a fourth threshold, it can be determined that the driver is in the fatigue state. For example, if the third threshold is 0.6, and the ratio is greater than 0.6, and if the fourth threshold is equal to 5, and the first counted-up frame amount is greater than 5, it can be determined that the driver is in the fatigue state. If it is determined that the driver is in the fatigue state, a voice prompting message may be outputted to alert the driver, to prevent traffic accidents caused by fatigue driving of the driver.

It should be noted that, by determining whether the ratio of the first counted-up frame amount to the total frame amount is greater than or equal to the preset third threshold and whether the first counted-up frame amount is greater than or equal to the preset fourth threshold, to determine whether the driver is in the fatigue state, it can be prevented that a quick blinking performed by the driver is erroneously determined as the fatigue state. For example, if the ratio of the first counted-up frame amount (the first counted-up frame amount is equal to 4) to the total frame amount (the total frame amount is equal to 5) is greater than the third threshold (the third threshold is equal to 0.6), but the first counted-up frame amount is equal to 4, which is less than the fourth threshold (the fourth threshold is equal to 5), because the obtained first counted-up frame amount is less than 5 frames, at this point the driver is not determined to be in the fatigue state.

The second mode may comprise the following steps:

according to a change of the eye-state data contained individually in the plurality of frames of eye images of the driver obtained after the correction, determining a blinking process of the driver;

determining a second counted-up frame amount during the blinking process, wherein the second counted-up frame amount is determined according to a counted-up frame amount of the eye images obtained after the correction during the blinking process whose state data are less than or equal to a preset fifth threshold; and

if the second counted-up frame amount is greater than or equal to a preset sixth threshold, determining that the driver is in the fatigue state.

That mode differs from the above first mode in that the meaning of the fifth threshold in that mode is the same as the meaning of the first threshold in the above first mode; in other words, if the eye-state data of the current frame of eye image obtained after the correction is less than or equal to the fifth threshold, it is considered that the one frame is a nearly-eye-closing frame or an eye-closing frame. In that mode, it is merely required to determine the second counted-up frame amount, and the second counted-up frame amount is the same as the first counted-up frame amount described in the above first mode, and is not discussed here further. The sixth threshold may be set to be 60 frames. For example, if the second counted-up frame amount is 60 frames, which is equal to the sixth threshold, it can be considered that the driver is in the fatigue state. In other words, if 30 frames of eye images are obtained every second, if 60 of the obtained frames are nearly-eye-closing frames or eye-closing frames, that means that the eye-closing duration is long, and it can be determined that the driver is in the fatigue state. If it is determined that the driver is in the fatigue state, a voice prompting message may be outputted to alert the driver, to prevent traffic accidents caused by fatigue driving of the driver.

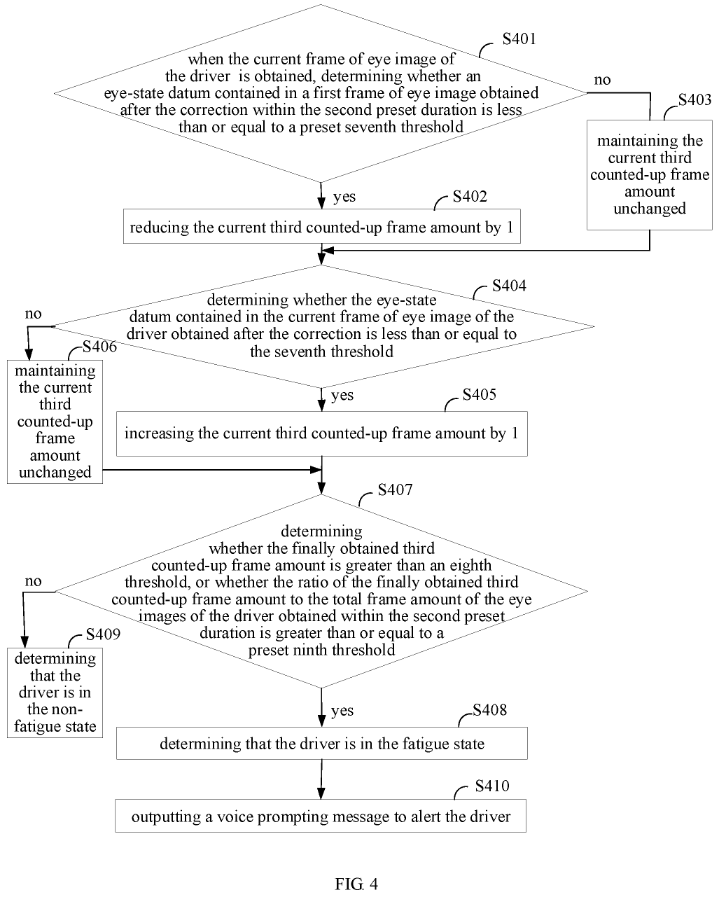

The third mode is: according to the eye-state data contained individually in the plurality of frames of eye images obtained after the correction within a second preset duration, determining whether the driver is in the fatigue state. That mode differs from the above two modes in that, by using the determining method using the second preset duration, it can be determined whether the driver is fatigued within a time period. For example, if, in one time of the blinking process, the proportions of the quantities of the nearly-eye-closing frames and the eye-closing frames do not obviously increase, but within a time period the frequency of blinking significantly increases, that is also the expression of fatigue, and it may be further determined whether the driver is fatigued by using the fatigue-frame amount within the second preset duration. In addition, it should be noted that, if the driver is so fatigued that the eyes have not completely opened again, and the driver has always squinted and continuously dozed, in such a case, it is also required to determine, by using the determining method using the second preset duration, whether the driver is fatigued. Particularly, that mode may comprise the following steps. Particularly, referring to FIG. 4, FIG. 4 is a flow chart of the particular steps of the fatigue detecting method according to another embodiment of the present disclosure.

The meaning of the seventh threshold in that mode is the same as the meanings of the first threshold in the above first mode and the fifth threshold in the above second mode; in other words, if the eye-state data of the current frame of eye image obtained after the correction is less than or equal to 0.3 (if the seventh threshold is set to be 0.3), it is considered that the one frame is a nearly-eye-closing frame or an eye-closing frame.

S401: when the current frame of eye image of the driver is obtained, determining whether eye-state data contained in a first frame of eye image obtained after the correction within the second preset duration is less than or equal to a preset seventh threshold.

If it is determined that the eye-state data contained in the first frame of eye image obtained after the correction within the second preset duration is less than or equal to the seventh threshold, then S402 is executed. If it is determined that the eye-state data contained in the first frame of eye image obtained after the correction within the second preset duration is greater than the seventh threshold, then S403 is executed.

For example, if the second preset duration is 1 minute, 30 frames of eye images can be obtained every second, and totally 1800 frames of eye images are obtained within the 1st minute, then, after the 1801th frame (the 1801th frame is obtained at the first second of the 2nd minute) of eye image has been obtained, th 1801 th frame of eye image is the obtained current frame of eye image of the driver. At this point, it is required to determine whether the eye-state data contained in the first frame of eye image obtained after the correction in the 1800 frames of eye images obtained at the 1st minute is less than or equal to the preset seventh threshold. If the eye-state data contained in the first frame of eye image obtained after the correction in the 1800 frames of eye images obtained at the 1st minute is equal to 0.2 (0.2 is less than the seventh threshold 0.3), then it is considered that the first frame within the 1st minute is a nearly-eye-closing frame or an eye-closing frame. At this point, it is required to execute S402. In other words, if a third counted-up frame amount that is counted up within the 1st minute is equal to 4, then it is required to reduce the current third counted-up frame amount by 1. In other words, after the execution of S402, the current third counted-up frame amount is equal to 3, to ensure that what is always counted up is the third counted-up frame amount within 1 minute from the current time. If the eye-state data contained in the first frame of eye image obtained after the correction in the 1800 frames of eye images obtained at the 1st minute is equal to 0.4 (0.4 is greater than the seventh threshold 0.3), then it is considered that the first frame within the 1st minute is not a nearly-eye-closing frame or an eye-closing frame. At this point, it is required to execute S403, i.e., maintaining the current third counted-up frame amount unchanged. After the execution of S403, the current third counted-up frame amount is still equal to 4.

S402: reducing the current third counted-up frame amount by 1.

The third counted-up frame amount is determined according to a counted-up frame amount of the eye images obtained after the correction within the preset duration whose state data are less than or equal to the seventh threshold.

After the execution of S402, S404 continues to be executed.

S403: maintaining the current third counted-up frame amount unchanged.

After the execution of S403, S404 continues to be executed.

S404: determining whether the eye-state data contained in the current frame of eye image of the driver obtained after the correction is less than or equal to the seventh threshold.

It should be noted that, if, after the execution of S402, S404 continues to be executed, if it is determined that the eye-state data contained in the current frame of eye image of the driver obtained after the correction is less than or equal to the seventh threshold, then S405 is executed. In other words, if the eye-state data contained in the current frame of eye image of the driver obtained after the correction is equal to 0.1 (0.1 is less than the seventh threshold 0.3), referring to the description in S401, at this point, it is required to increase the current third counted-up frame amount obtained after the execution of S402 (the current third counted-up frame amount obtained after the execution of S402 is equal to 3) by 1 to obtain the third counted-up frame amount, and the current third counted-up frame amount is equal to 3 plus 1; in other words, the current third counted-up frame amount is equal to 4, or, in other words, the current third counted-up frame amount obtained after the execution of S402 (in other words, the finally obtained third counted-up frame amount) is equal to 4. If it is determined that the eye-state data contained in the current frame of eye image of the driver obtained after the correction is greater than the seventh threshold, then S406 is executed. In other words, if the eye-state data contained in the current frame of eye image of the driver obtained after the correction is equal to 0.5 (0.5 is greater than the seventh threshold 0.3), referring to the description in S401, at this point, it is required to maintain the third counted-up frame amount after the execution of S402, i.e., to maintain the current third counted-up frame amount after the execution of S402; in other words, the current third counted-up frame amount is still equal to 3, or, in other words, the current third counted-up frame amount obtained after the execution of S406 (in other words, the finally obtained third counted-up frame amount) is equal to 3.

It should be noted that, if, after the execution of S403, S404 continues to be executed, if it is determined that the eye-state data contained in the current frame of eye image of the driver obtained after the correction is less than or equal to the seventh threshold, then S405 is executed. In other words, if the eye-state data contained in the current frame of eye image of the driver obtained after the correction is equal to 0.1 (0.1 is less than the seventh threshold 0.3), referring to the description in S401, at this point, it is required to increase the third counted-up frame amount obtained after the execution of S403 by 1, and after the execution of S403, the third counted-up frame amount is equal to 4; in other words, the third counted-up frame amount is equal to 4 plus 1, or, in other words, the current third counted-up frame amount obtained after the execution of S405 (in other words, the finally obtained third counted-up frame amount) is equal to 5. Subsequently, S407 is executed. If it is determined that the eye-state data contained in the current frame of eye image of the driver obtained after the correction is greater than the seventh threshold, then S406 is executed. In other words, if the eye-state data contained in the current frame of eye image of the driver obtained after the correction is equal to 0.5 (0.5 is greater than the seventh threshold 0.3), referring to the description in S401, at this point, it is required to maintain the third counted-up frame amount after the execution of S403, and, because after the execution of S403, the third counted-up frame amount is equal to 4, the third counted-up frame amount obtained after the execution of S406 (in other words, the finally obtained third counted-up frame amount) is still equal to 4. Subsequently, S407 is executed.

S405: increasing the current third counted-up frame amount by 1.

S406: maintaining the current third counted-up frame amount unchanged.

S407: determining whether the finally obtained third counted-up frame amount is greater than an eighth threshold, or, determining whether the ratio of the finally obtained third counted-up frame amount to the total frame amount of the eye images of the driver obtained within the second preset duration is greater than or equal to a preset ninth threshold.

If the finally obtained third counted-up frame amount is greater than an eighth threshold, or, if the ratio of the finally obtained third counted-up frame amount to the total frame amount of the eye images of the driver obtained within the second preset duration is greater than or equal to a preset ninth threshold, then S408 is executed, and if no, S409 is executed.

For example, after the execution of S403, S404 and S405 continue to be executed, the finally obtained third counted-up frame amount obtained after the execution of S405 is equal to 5, and if the second preset duration is 1 minute, the ratio is obtained by dividing 5 by 30. As another example, after the execution of S403, S404 and S406 continue to be executed, the finally obtained third counted-up frame amount obtained after the execution of S406 is equal to 4, and the ratio is obtained by dividing 4 by 30.

S408: determining that the driver is in the fatigue state.

S409: determining that the driver is in the non-fatigue state.

S410: if it is determined that the driver is in the fatigue state, outputting a voice prompting message to alert the driver.

If it is determined that the driver is in the fatigue state, a voice prompting message is outputted to alert the driver, to prevent traffic accidents caused by fatigue driving of the driver.

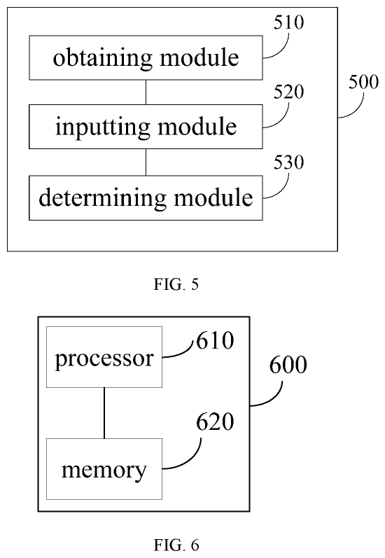

FIG. 5 is a schematic structural diagram of the fatigue detecting apparatus according to an embodiment of the present disclosure. The fatigue detecting apparatus is usually embodied as software and/or hardware. Referring to FIG. 5, the fatigue detecting apparatus 500 comprises the following modules: an obtaining module 510, an inputting module 520 and a determining module 530.

The obtaining module 510 is configured for obtaining an eye image of a driver. The inputting module 520 is configured for inputting the eye image into a target convolutional neural network, to obtain eye-state data contained in the eye image, wherein the eye-state data represents a degree of opening of an eye of the driver, and the target convolutional neural network is obtained by training a convolutional neural network by using eye-image samples that are collected in advance. The determining module 530 is configured for, in a condition that respective eye-state data of a plurality of frames of eye images are obtained, according to the respective eye-state data of the plurality of frames of eye images, determining whether the driver is in a fatigue state.

The fatigue detecting apparatus according to the present embodiment, by obtaining an eye image of a driver; inputting the eye image into a target convolutional neural network, to obtain eye-state data contained in the eye image, wherein the eye-state data represents a degree of opening of an eye of the driver, and the target convolutional neural network is obtained by training a convolutional neural network by using eye-image samples that are collected in advance; and according to the eye-state data contained individually in the plurality of frames of eye images of the driver, determining whether the driver is in a fatigue state, can more easily determine whether the driver is in the fatigue state, and, by using the lightweight target convolutional neural network, can realize real-time detection on whether the driver is in the fatigue state.

Optionally, the determining module 530 is particularly configured for, according to eye-state data of each of acquired frames of eye images of the driver within a first preset duration, determining a correcting parameter; according to the correcting parameter, correcting the eye-state data contained individually in the plurality of frames of eye images of the driver; and according to the eye-state data contained individually in the plurality of frames of eye images of the driver obtained after the correction, determining whether the driver is in the fatigue state.

Optionally, the apparatus 500 may further comprise an obtaining module configured for obtaining head deflection angles of the driver corresponding individually to the plurality of frames of eye images.

Correspondingly, the determining module 530 is further configured for, according to the correcting parameter and the head deflection angles of the driver corresponding individually to the plurality of frames of eye images, correcting the eye-state data contained individually in the plurality of frames of eye images of the driver; and according to the eye-state data contained individually in the plurality of frames of eye images of the driver obtained after the correction, determining whether the driver is in the fatigue state.

Optionally, the determining module 530 is particularly configured for, according to a change of the eye-state data contained individually in the plurality of frames of eye images of the driver obtained after the correction, determining a blinking process of the driver; determining a first counted-up frame amount during the blinking process and a total frame amount during the blinking process, wherein the first counted-up frame amount is determined according to a counted-up frame amount of the eye images during the blinking process whose state data are less than or equal to a preset first threshold, the total frame amount is determined according to a counted-up frame amount of the eye images during the blinking process whose state data are less than or equal to a preset second threshold, and the first threshold is less than the second threshold; and if a ratio of the first counted-up frame amount to the total frame amount is greater than or equal to a preset third threshold and the first counted-up frame amount is greater than or equal to a preset fourth threshold, determining that the driver is in the fatigue state.

Optionally, the determining module 530 is particularly configured for, according to a change of the eye-state data contained individually in the plurality of frames of eye images of the driver obtained after the correction, determining a blinking process of the driver; determining a second counted-up frame amount during the blinking process, wherein the second counted-up frame amount is determined according to a counted-up frame amount of the eye images obtained after the correction during the blinking process whose state data are less than or equal to a preset fifth threshold; and if the second counted-up frame amount is greater than or equal to a preset sixth threshold, determining that the driver is in the fatigue state.

Optionally, the determining module 530 is particularly configured for, according to the eye-state data contained individually in the plurality of frames of eye images obtained after the correction within a second preset duration, determining whether the driver is in the fatigue state.

Optionally, the determining module 530 is particularly configured for determining whether eye-state data contained in a current frame of eye image of the driver obtained after the correction within the second preset duration is less than or equal to a seventh threshold; if it is determined that the eye-state data contained in the current frame of eye image of the driver obtained after the correction is less than or equal to the seventh threshold, increasing the current third counted-up frame amount by 1; and if the current third counted-up frame amount is greater than an eighth threshold or a ratio of the current third counted-up frame amount to a total frame amount of the eye images of the driver obtained within the second preset duration is greater than or equal to a preset ninth threshold, determining that the driver is in the fatigue state.

Optionally, the determining module 530 is further configured for, when the current frame of eye image of the driver is obtained, determining whether eye-state data contained in a first frame of eye image obtained after the correction within the second preset duration is less than or equal to the seventh threshold; and

if it is determined that the eye-state data contained in the first frame of eye image obtained after the correction within the second preset duration is less than or equal to the seventh threshold, reducing the current third counted-up frame amount by 1, wherein the third counted-up frame amount is determined according to a counted-up frame amount of the eye images obtained after the correction within the preset duration whose state data are less than or equal to the seventh threshold.

Optionally, the determining module 530 is further configured for, if it is determined that the eye-state data contained in the first frame of eye image obtained after the correction within the second preset duration is less than or equal to the seventh threshold, reducing the current third counted-up frame amount by 1; determining whether the eye-state data contained in the current frame of eye image of the driver obtained after the correction is less than or equal to the seventh threshold; if it is determined that the eye-state data contained in the current frame of eye image of the driver obtained after the correction is greater than the seventh threshold, maintaining the current third counted-up frame amount unchanged; and if the current third counted-up frame amount is greater than an eighth threshold, or, the ratio of the current third counted-up frame amount to the total frame amount of the eye images of the driver obtained within the second preset duration is greater than or equal to a ninth threshold, determining that the driver is in the fatigue state.

Optionally, the determining module 530 is further configured for, if it is determined that the eye-state data contained in the first frame of eye image obtained after the correction within the second preset duration is greater than the seventh threshold, maintaining the current third counted-up frame amount; determining whether the eye-state data contained in the current frame of eye image of the driver obtained after the correction is less than or equal to the seventh threshold; if it is determined that the eye-state data contained in the current frame of eye image of the driver obtained after the correction is less than or equal to the seventh threshold, increasing the current third counted-up frame amount by 1; and if the current third counted-up frame amount is greater than an eighth threshold, or, the ratio of the current third counted-up frame amount to the total frame amount of the eye images of the driver obtained within the second preset duration is greater than or equal to a ninth threshold, determining that the driver is in the fatigue state.

Optionally, the apparatus may further comprise an outputting module, and the outputting module is configured for, if it is determined that the driver is in the fatigue state, outputting a voice prompting message to alert the driver.

Optionally, the obtaining module 510 is particularly configured for obtaining a face image of a driver; acquiring the coordinates of the characteristic points of the eyes contained in the face image; according to the coordinates of the characteristic points of the eyes, determining an image region that encloses the eyes; and according to the image region that encloses the eyes, clipping the face image, to obtain an eye image of the driver.

Optionally, the obtaining module 510 is particularly configured for acquiring the coordinates of the characteristic points of the left eye and the coordinates of the characteristic points of the right eye of the face image. Correspondingly, the determining module 530 is particularly configured for, according to the coordinates of the characteristic points of the left eye/the right eye, determining the area of a smallest first rectangular block that encloses the left eye/the right eye, and, according to the coordinates of the characteristic points of the right eye/the left eye, determining the area of a smallest second rectangular block that encloses the right eye/the left eye; selecting the largest area from the area of the first rectangular block and the area of the second rectangular block; and determining the rectangular block corresponding to the largest area to be the image region that encloses the eyes.

Optionally, the apparatus may further comprise a training module, and the training module is configured for, before the eye image is inputted into the target convolutional neural network, obtaining an eye-image sample by using a rendering tool; according to coordinates of characteristic points of a left eye and a right eye contained in the eye-image sample, clipping the eye-image sample, to obtain an image that encloses the left eye and the right eye of the eye-image sample; flipping the image that encloses the left eye and the right eye of the eye-image sample into an image of the right eye and the left eye; and inputting the image that encloses the left eye and the right eye of the eye-image sample and the image of the right eye and the left eye obtained after the flipping into the convolutional neural network, and training, to obtain the target convolutional neural network.

Optionally, the training module is particularly configured for, if the image that encloses the left eye of the eye-image sample and the image of the right eye are RGB images, inputting red channels of the image that encloses the left eye of the eye-image sample and the image of the right eye into the convolutional neural network, and training; and

if the image that encloses the left eye of the eye-image sample and the image of the right eye are infrared images, inputting the image that encloses the left eye of the eye-image sample and the image of the right eye into the convolutional neural network, and training.

In addition, an embodiment of the present disclosure further provides a fatigue detecting apparatus. As shown in FIG. 6, FIG. 6 is a schematic structural diagram of the fatigue detecting apparatus according to another embodiment of the present disclosure. The fatigue detecting apparatus 600 comprises a processor 610, a memory 620 and a computer program that is stored in the memory 620 and is executable in the processor 610, and the computer program, when executed by the processor 610, implements the steps of the embodiments of the fatigue detecting method stated above, to obtain the same technical effect, which, in order to avoid replication, is not discussed here further.

An embodiment of the present disclosure further provides a computer-readable storage medium, wherein the computer-readable storage medium stores a computer program, and the computer program, when executed by a processor, implements the steps of the embodiments of the fatigue detecting method stated above, to obtain the same technical effect, which, in order to avoid replication, is not discussed here further. The computer-readable storage medium may be a Read-Only Memory (referred to for short as ROM), a Random Access Memory (referred to for short as RAM), a diskette, an optical disc and so on.

Regarding the device embodiments, because they are substantially similar to the process embodiments, they are described simply, and the related parts may refer to the description on the process embodiments.

The above-described device embodiments are merely illustrative, wherein the units that are described as separate components may or may not be physically separate, and the components that are displayed as units may or may not be physical units; in other words, they may be located at the same one location, and may also be distributed to a plurality of network units. Part or all of the modules may be selected according to the actual demands to realize the purposes of the solutions of the embodiments. A person skilled in the art can understand and implement the technical solutions without paying creative work.

Each component embodiment of the present disclosure may be implemented by hardware, or by software modules that are operated on one or more processors, or by a combination thereof. A person skilled in the art should understand that some or all of the functions of some or all of the components of the calculating and processing device according to the embodiments of the present disclosure may be implemented by using a microprocessor or a digital signal processor (DSP) in practice. The present disclosure may also be implemented as apparatus or device programs (for example, computer programs and computer program products) for implementing part of or the whole of the method described herein. Such programs for implementing the present disclosure may be stored in a computer-readable medium, or may be in the form of one or more signals. Such signals may be downloaded from an Internet website, or provided on a carrier signal, or provided in any other forms.

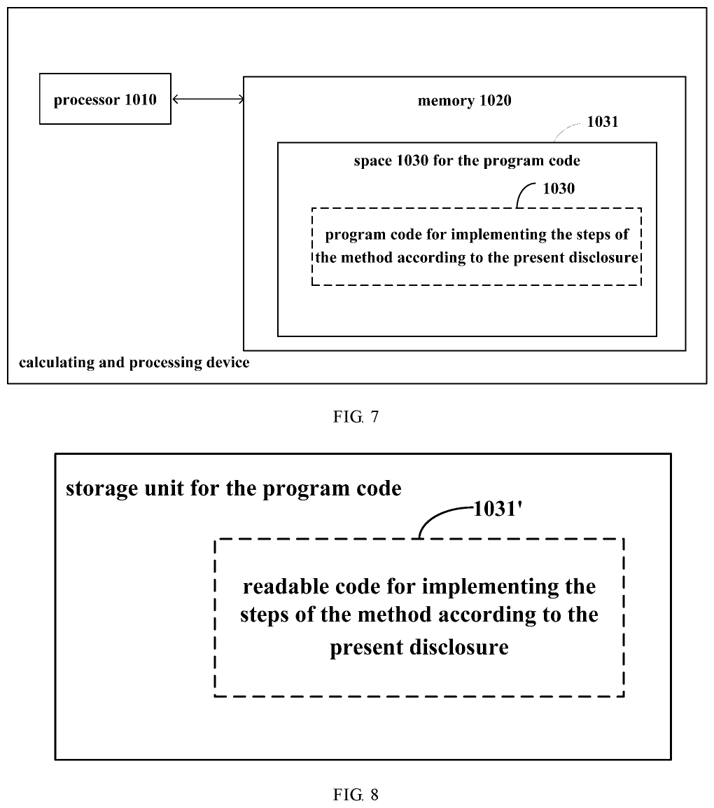

For example, FIG. 7 shows a calculating and processing device that can implement the method according to the present disclosure. The calculating and processing device traditionally comprises a processor 1010 and a computer program product or computer-readable medium in the form of a memory 1020. The memory 1020 may be electronic memories such as flash memory, EEPROM (Electrically Erasable Programmable Read Only Memory), EPROM, hard disk or ROM. The memory 1020 has the storage space 1030 of the program code 1031 for implementing any steps of the above method. For example, the storage space 1030 for program code may contain program codes 1031 for individually implementing each of the steps of the above method. Those program codes may be read from one or more computer program products or be written into the one or more computer program products. Those computer program products include program code carriers such as a hard disk, a compact disk (CD), a memory card or a floppy disk. Such computer program products are usually portable or fixed storage units as shown in FIG. 8. The storage unit may have storage segments or storage spaces with similar arrangement to the memory 1020 of the calculating and processing device in FIG. 7. The program codes may, for example, be compressed in a suitable form. Generally, the storage unit contains a computer-readable code 1031′, which can be read by a processor like 1010. When those codes are executed by the calculating and processing device, the codes cause the calculating and processing device to implement each of the steps of the method described above.

The embodiments of the description are described in the mode of progression, each of the embodiments emphatically describes the differences from the other embodiments, and the same or similar parts of the embodiments may refer to each other.

A person skilled in the art should understand that the embodiments of the present disclosure may be provided as a method, a device, or a computer program product. Therefore, the embodiments of the present disclosure may take the form of a complete hardware embodiment, a complete software embodiment, or an embodiment combining software and hardware. Furthermore, the embodiments of the present disclosure may take the form of a computer program product implemented on one or more computer-usable storage media (including but not limited to a disk storage, a CD-ROM, an optical memory and so on) containing a computer-usable program code therein.

In a typical configuration, the computer device comprises one or more processors (CPU), an input/output interface, a network interface and an internal storage. The internal storage may be in the form of a volatile memory, a random access memory (RAM) and/or a nonvolatile internal storage among computer-readable media, for example, a read-only memory (ROM) or a flash memory (flash RAM). The internal storage is an example of computer-readable media. Computer-readable media include permanent and non-permanent, or movable and immovable media, and may realize information storage by using any method or technique. The information may be a computer-readable instruction, a data structure, a program module or other data. The examples of the storage medium of the computer include but are not limited to a phase change memory (PRAM), a static random access memory (SRAM), a dynamic random access memory (DRAM), other types of random access memories (RAM), a read-only memory (ROM), an electrically erasable programmable read-only memory (EEPROM), a flash memory or other techniques of internal storage, a read-only-optical-disc read-only memory (CD-ROM), a digital versatile disc (DVD) or other optical storages, a magnetic cassette, a magnetic-tape magnetic-disk storage, or other magnetic storage devices, or any other non-transmission medium, and may be used to store information accessible by a calculating device. According to the definition herein, the computer-readable media do not include non-permanent computer-readable media (transitory media), such as a modulated data signal and a carrier wave.

The embodiments of the present disclosure are described with reference to the flow charts and/or block diagrams of the method, the terminal device (system), and the computer program product according to the embodiments of the present disclosure. It should be understood that each flow and/or block in the flow charts and/or block diagrams, and combinations of the flows and/or blocks in the flow charts and/or block diagrams, may be implemented by a computer program instruction. The computer program instructions may be provided to a processor of a general-purpose computer, a special-purpose computer, an embedded processor, or another programmable data processing terminal device to generate a machine, so that a device for implementing the functions specified in one or more flows of the flow charts and/or one or more blocks of the block diagrams can be generated by instructions executed by the processor of the computers or the other programmable data processing terminal device.

The computer program instructions may also be stored in a computer-readable memory that can instruct the computers or the other programmable data processing terminal device to operate in a specific mode, so that the instructions stored in the computer-readable memory generate an article comprising an instruction device, and the instruction device implements the functions specified in one or more flows of the flow charts and/or one or more blocks of the block diagrams.

The computer program instructions may also be loaded to the computers or the other programmable data processing terminal device, so that the computers or the other programmable data processing terminal device implement a series of operation steps to generate the computer-implemented processes, whereby the instructions executed in the computers or the other programmable data processing terminal device provide the steps for implementing the functions specified in one or more flows of the flow charts and/or one or more blocks of the block diagrams.

Although preferable embodiments of the embodiments of the present disclosure have been described, once a person skilled in the art has known the essential inventive concept, he may make further variations and modifications on those embodiments. Therefore, the appended claims are intended to be interpreted as including the preferable embodiments and all of the variations and modifications that fall within the scope of the embodiments of the present disclosure.

Finally, it should also be noted that, in the present text, relation terms such as first and second are merely intended to distinguish one entity or operation from another entity or operation, and that does not necessarily require or imply that those entities or operations have therebetween any such actual relation or order. Furthermore, the terms “include”, “comprise” or any variants thereof are intended to cover non-exclusive inclusions, so that processes, methods, articles or terminal devices that include a series of elements do not only include those elements, but also include other elements that are not explicitly listed, or include the elements that are inherent to such processes, methods, articles or terminal devices. Unless further limitation is set forth, an element defined by the wording “comprising a . . . ” does not exclude additional same element in the process, method, article or terminal device comprising the element.

The fatigue detecting method and apparatus and the readable storage medium according to the present disclosure has been described in detail above. The principle and the embodiments of the present disclosure are described herein with reference to the particular examples, and the description of the above embodiments is merely intended to facilitate to understand the method according to the present disclosure and its core concept. Moreover, for a person skilled in the art, according to the concept of the present disclosure, the particular embodiments and the range of application may be varied. In conclusion, the contents of the description should not be understood as limiting the present disclosure.

1. A fatigue detecting method, wherein the method comprises:
obtaining an eye image of a driver;
inputting the eye image into a target convolutional neural network, to obtain eye-state data contained in the eye image, wherein the eye-state data represents a degree of opening of an eye of the driver, and the target convolutional neural network is obtained by training a convolutional neural network by using eye-image samples that are collected in advance; and
in a condition that respective eye-state data of a plurality of frames of eye images are obtained, according to the respective eye-state data of the plurality of frames of eye images, determining whether the driver is in a fatigue state.

2. The method according to claim 1, wherein the step of, according to the respective eye-state data of the plurality of frames of eye images, determining whether the driver is in the fatigue state comprises:
according to eye-state data of each of acquired frames of eye images of the driver within a first preset duration, determining a correcting parameter;
according to the correcting parameter, correcting the eye-state data contained individually in the plurality of frames of eye images of the driver; and
according to the eye-state data contained individually in the plurality of frames of eye images of the driver obtained after the correction, determining whether the driver is in the fatigue state.

3. The method according to claim 2, wherein the step of, according to the correcting parameter, correcting the eye-state data contained individually in the plurality of frames of eye images of the driver comprises:
obtaining head deflection angles of the driver corresponding individually to the plurality of frames of eye images; and
according to the correcting parameter and the head deflection angles of the driver corresponding individually to the plurality of frames of eye images, correcting the eye-state data contained individually in the plurality of frames of eye images of the driver.

4. The method according to claim 2, wherein the step of, according to the eye-state data contained individually in the plurality of frames of eye images of the driver obtained after the correction, determining whether the driver is in the fatigue state comprises:
according to a change of the eye-state data contained individually in the plurality of frames of eye images of the driver obtained after the correction, determining a blinking process of the driver;
determining a first counted-up frame amount during the blinking process and a total frame amount during the blinking process, wherein the first counted-up frame amount is determined according to a counted-up frame amount of the eye images during the blinking process whose state data are less than or equal to a preset first threshold, the total frame amount is determined according to a counted-up frame amount of the eye images during the blinking process whose state data are less than or equal to a preset second threshold, and the first threshold is less than the second threshold; and
if a ratio of the first counted-up frame amount to the total frame amount is greater than or equal to a preset third threshold and the first counted-up frame amount is greater than or equal to a preset fourth threshold, determining that the driver is in the fatigue state.

5. The method according to claim 2, wherein the step of, according to the eye-state data contained individually in the plurality of frames of eye images of the driver obtained after the correction, determining whether the driver is in the fatigue state comprises:
according to a change of the eye-state data contained individually in the plurality of frames of eye images of the driver obtained after the correction, determining a blinking process of the driver;
determining a second counted-up frame amount during the blinking process, wherein the second counted-up frame amount is determined according to a counted-up frame amount of the eye images obtained after the correction during the blinking process whose state data are less than or equal to a preset fifth threshold; and
if the second counted-up frame amount is greater than or equal to a preset sixth threshold, determining that the driver is in the fatigue state.

6. The method according to claim 2 or 3, wherein the step of, according to the eye-state data contained individually in the plurality of frames of eye images of the driver obtained after the correction, determining whether the driver is in the fatigue state comprises:
according to the eye-state data contained individually in the plurality of frames of eye images obtained after the correction within a second preset duration, determining whether the driver is in the fatigue state.

7. The method according to claim 6, wherein the step of, according to the eye-state data contained individually in the plurality of frames of eye images obtained after the correction within the second preset duration, determining whether the driver is in the fatigue state comprises:
determining whether eye-state data contained in a current frame of eye image of the driver obtained after the correction within the second preset duration is less than or equal to a seventh threshold;
if it is determined that the eye-state data contained in the current frame of eye image of the driver obtained after the correction is less than or equal to the seventh threshold, increasing a current third counted-up frame amount by 1; and
if the current third counted-up frame amount is greater than an eighth threshold or a ratio of the current third counted-up frame amount to a total frame amount of the eye images of the driver obtained within the second preset duration is greater than or equal to a preset ninth threshold, determining that the driver is in the fatigue state.

8. The method according to claim 7, wherein the method further comprises:
when the current frame of eye image of the driver is obtained, determining whether eye-state data contained in a first frame of eye image obtained after the correction within the second preset duration is less than or equal to the seventh threshold; and
if it is determined that the eye-state data contained in the first frame of eye image obtained after the correction within the second preset duration is less than or equal to the seventh threshold, reducing the current third counted-up frame amount by 1, wherein the third counted-up frame amount is determined according to a counted-up frame amount of the eye images obtained after the correction within the preset duration whose state data are less than or equal to the seventh threshold.

9. The method according to claim 8, wherein the method further comprises:
if it is determined that the eye-state data contained in the current frame of eye image of the driver obtained after the correction is greater than the seventh threshold, maintaining the current third counted-up frame amount unchanged.

10. The method according to claim 9, wherein the method further comprises:
if it is determined that the eye-state data contained in the first frame of eye image obtained after the correction within the second preset duration is greater than the seventh threshold, maintaining the current third counted-up frame amount.

11. The method according to claim 1, wherein before the step of inputting the eye image into the target convolutional neural network, the method further comprises:
obtaining an eye-image sample by using a rendering tool;
according to coordinates of characteristic points of a left eye and a right eye contained in the eye-image sample, clipping the eye-image sample, to obtain an image that encloses the left eye and the right eye of the eye-image sample;
flipping the image that encloses the left eye and the right eye of the eye-image sample into an image of the right eye and the left eye; and
inputting the image that encloses the left eye and the right eye of the eye-image sample and the image of the right eye and the left eye obtained after the flipping into the convolutional neural network, and training, to obtain the target convolutional neural network.

12. The method according to claim 11, wherein the step of inputting the image that encloses the left eye and the right eye of the eye-image sample and the image of the right eye and the left eye obtained after the flipping into the convolutional neural network, and training comprises:
if the image that encloses the left eye of the eye-image sample and the image of the right eye are RGB images, inputting red channels of the image that encloses the left eye of the eye-image sample and the image of the right eye into the convolutional neural network, and training; and
if the image that encloses the left eye of the eye-image sample and the image of the right eye are infrared images, inputting the image that encloses the left eye of the eye-image sample and the image of the right eye into the convolutional neural network, and training.

13. The method according to 1, wherein the target convolutional neural network is a lightweight target convolutional neural network.

14. (canceled)

15. A fatigue detecting apparatus, wherein the fatigue detecting apparatus comprises a processor, a memory and a computer program that is stored in the memory and is executable in the processor, and the computer program, when executed by the processor, implements the steps of the fatigue detecting method according to claim 1.

16. A computer program, wherein the computer program comprises a computer-readable code, and when the computer-readable code is executed on a calculating and processing device, the computer-readable code causes the calculating and processing device to implement the fatigue detecting method according to claim 1.

17. A computer-readable storage medium, wherein the computer-readable storage medium stores the computer program according to claim 16.

18. The fatigue detecting apparatus according to claim 15, wherein the step of, according to the respective eye-state data of the plurality of frames of eye images, determining whether the driver is in the fatigue state comprises:
according to eye-state data of each of acquired frames of eye images of the driver within a first preset duration, determining a correcting parameter;
according to the correcting parameter, correcting the eye-state data contained individually in the plurality of frames of eye images of the driver; and
according to the eye-state data contained individually in the plurality of frames of eye images of the driver obtained after the correction, determining whether the driver is in the fatigue state.

19. The fatigue detecting apparatus according to claim 16, wherein the step of, according to the correcting parameter, correcting the eye-state data contained individually in the plurality of frames of eye images of the driver comprises:
obtaining head deflection angles of the driver corresponding individually to the plurality of frames of eye images; and
according to the correcting parameter and the head deflection angles of the driver corresponding individually to the plurality of frames of eye images, correcting the eye-state data contained individually in the plurality of frames of eye images of the driver.

20. The fatigue detecting apparatus according to claim 16, wherein the step of, according to the eye-state data contained individually in the plurality of frames of eye images of the driver obtained after the correction, determining whether the driver is in the fatigue state comprises:
according to a change of the eye-state data contained individually in the plurality of frames of eye images of the driver obtained after the correction, determining a blinking process of the driver;
determining a first counted-up frame amount during the blinking process and a total frame amount during the blinking process, wherein the first counted-up frame amount is determined according to a counted-up frame amount of the eye images during the blinking process whose state data are less than or equal to a preset first threshold, the total frame amount is determined according to a counted-up frame amount of the eye images during the blinking process whose state data are less than or equal to a preset second threshold, and the first threshold is less than the second threshold; and
if a ratio of the first counted-up frame amount to the total frame amount is greater than or equal to a preset third threshold and the first counted-up frame amount is greater than or equal to a preset fourth threshold, determining that the driver is in the fatigue state.

21. The fatigue detecting apparatus according to claim 16, wherein the step of, according to the eye-state data contained individually in the plurality of frames of eye images of the driver obtained after the correction, determining whether the driver is in the fatigue state comprises:
according to a change of the eye-state data contained individually in the plurality of frames of eye images of the driver obtained after the correction, determining a blinking process of the driver;
determining a second counted-up frame amount during the blinking process, wherein the second counted-up frame amount is determined according to a counted-up frame amount of the eye images obtained after the correction during the blinking process whose state data are less than or equal to a preset fifth threshold; and
if the second counted-up frame amount is greater than or equal to a preset sixth threshold, determining that the driver is in the fatigue state.
